(19) United States
(12) Patent Application Publication
(10) Pub. No.: US 2007/0062114 A1
(43) Pub. Date: Mar. 22, 2007

(54) POT-IN-POT GROWING SYSTEM FOR PLANTS

(76) Inventor: Thomas R. Kruer, Erlanger, KY (US)

Correspondence Address: EGBERT LAW OFFICES, 412 MAIN STREET, 7TH FLOOR, HOUSTON, TX, 77002, US

(21) Appl. No.: 11/464,708

(22) Filed: Aug. 15, 2006

Related U.S. Application Data
(60) Provisional application No. 60/708,007, filed on Aug. 15, 2005.

(51) Int. Cl. A01G 9/02

(52) U.S. Cl. 47/65.8

(57) ABSTRACT

The present invention is a pot-in-pot production system with components and a combination that facilitates the growing of nursery plants in containers while minimizing costs. The new system includes a socket pot container with at least one corrugation that is resistant to crushing and frost; a water-deflecting cover that controls the amount of water delivered to the plant to minimize leachate; and an efficient, inexpensive drip irrigation device that evenly distributes water to the plant for a consistent and healthy root system. The irrigation device can be attached to or be integrated into the water-deflecting cover.

### RELATED U.S. APPLICATIONS

The present utility patent application is based upon Provisional Patent Application Ser. No. 60/708007 filed on 15 Aug. 2005 and entitled “ENCLOSED GROWING SYSTEM FOR NURSERY PLANTS”, presently pending.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention relates to a system to facilitate the growing of nursery grown plants by providing ideal growing conditions. Specifically, this invention relates to components and assembly of a new pot-in-pot production system for woody plants grown in containers that are set on or into the ground. Also, the invention relates to providing precise control over the delivery of water and irrigation to the container.

### BACKGROUND OF THE INVENTION

The pot-in-pot growing system is a relatively new technology for growing plants in containers which comprises a “socket” pot permanently installed in or on the ground and a “production” pot or growing bag, containing the plant and growing media, placed inside the “socket” pot, as in the invention disclosed in U.S. Pat. No. 6,223,466. At the end of the growing period, the plant is harvested by removing the “production” pot or growing bag from the “socket” pot. The “production” pot or growing bag is sold with the plant.

The current Pot-in-Pot growing method provides a number of advantages to the grower. Most important, the plants are securely supported in the ground, thus reducing the risk of blowover from high wind or tipping from accidental contact with humans, animals, carts, machinery and the like. Secondly, by being in the ground rather than on the surface, the plant roots are protected from exposure to excessive hot or freezing temperatures. The temperature is regulated by the surrounding soil to approximately 70 degrees. This stable and moderate temperature is ideal for growing plants.

However, there are a number of problems associated with current Pot-in-Pot production components and growing methods. The main issue that inhibits the widespread acceptance of the current growing method is the cost of installation. Currently, leach lines must be installed beneath the rows of socket pots to collect any leachate (water and chemicals leaching through the “production” pot). These leach line are costly to install and maintain. A new system design is needed to decrease these costs.

Any leachate coming through the pots must be collected and treated prior to reusing or discharging the water m order to minimize overfeeding and environmental damage. The cost of treating the chemical-laden leachate is a significant ongoing expense for the grower.

Contributing to the amount, and thus the cost associated with leachate is the fact that current pot-in-pot systems are not capable of precisely controlling water delivery. Overhead spray irrigation devices are very inefficient with as little as 10% of the water actually being used by the plant. Micro-spray devices deliver water too quickly for the media to absorb resulting in up to 90% of the irrigation becoming leachate. Drip emitters do not distribute the irrigation water over the entire surface of the media so channeling often occurs through the pot with little water being retained in the growing media and used by the plant. And finally, any rain water entering the pot, that is not absorbed by the growing media and plant, becomes leachate. A new device is needed to eliminate excess water entering the “production” container.

Excessive leachate is further compounded by the fact that when the soiless growing media ages or dries, it tends to shrink and pull away from the walls of the container. Therefore, when irrigation is delivered by spraying devices, the water tends to hit the container wall and channel straight out of he bottom drain holes. Wind will tend to deflect some of the fine droplets of sprayed irrigation water out of the pot resulting in too little water. A new system is needed to precisely control water delivery to the container.

Current irrigations devices such as microspray and drip emitters are typically attached to a spike which is pushed into the top surface of the growing media. As the soil becomes wet, these spikes tend to tilt or twist causing inconsistent water delivery. The spikes are not registered in any way to the pot and are free to move under their own weight or the pull of the irrigation supply tubing. Monitoring and repositioning of these irrigation devices becomes a constant chore. There is a need for a simple device that registers the irrigation to the “production” pot and is rigid enough to hold it in place.

Another issue to be addressed is that when irrigation is not evenly distributed throughout the growing media, as when delivered by drip emitters, the plant will send out roots looking for a reliable water source. This is not desirable for two reasons. First these roots will eventually grow out to the inner wall of the “production” pot. The roots must be terminated at that point, currently using a variety of expensive, or time-consuming techniques, or they will start circling. These circling roots will grow and eventually girdle the tree when planted in its final location. Secondly, roots “chasing” the water through the bottom drainage holes will eventually grow into the surrounding soil and take root. This is a common and major issue which tends to defeat the purpose of the pot-in-pot growing growing method. When harvested, these anchored roots are lost. There is also usually irreparable damage done to the “socket” pot as the roots are extracted. In contrast, irrigation delivered slowly and evenly over the surface of the pot provides the plant with proper moisture and tends to minimize any tendency to root out the production container. A new system is needed to precisely deliver water slowly and evenly throughout the container.

A second issue related to root growth is the “shelf life” of the plant after harvesting. When grown with current production growing methods, the typical root system in a container is concentrated in the area around the outside of the soil ball. The roots only utilize about 30 to 40% of the soil ball, then they start choking themselves out. This is an issue in all current container-grown plants. The soil tends to lose moisture from the outside inward, thus the roots are easily stressed. A new system is needed to effectively encourage the plant to fill the other 60-70% of the soil ball with roots. The intent is to precisely control the distribution of water so that the shelf life can be increased. The result is a larger plant that will appreciate in value without compromising its health and vigor.

Another large problem with current pot-in-pot productions is the temperature shock to the root system at harvest time. A container-grown tree is in largest demand during the hot summer when a field grown tree cannot be dug. During the summer, when the root system is in contact with the “production” container wall, heat is not a problem as long as the pot is underground, as mentioned above. When it is harvested, that container wall can go from approximately 70 degrees to 110 degrees within minutes. This temperature shock destroys the tender, critical root hairs near the pot wall. Research has shown that the location, control, and distribution of irrigation water can indeed manipulate plant root growth. A new device is needed which concentrates the root hairs away from the pot walls to decrease shock at harvest.

Winter freezing is also a problem with current pot-in-pot growing methods when a “production” pot becomes frozen in the “socket”. This is typically caused by excess water and compounded by the fact that the “socket” pot has the same taper and shape as the “production” pot. The “socket” pot can also frost heave out of the ground over the course of a few winter in northern climates, causing problems unless it is somehow anchored into the ground. Current “socket” pots do not have provision for anchoring into the ground.

An additional problem is that the “socket” pot can be crushed when the surrounding soil expands with water or frost. Crushing is worse at the time of installation and requires tight control of dimensions and conditions to avoid. Thus, there is the need for a strong and durable “socket” pot that stays m the ground m freezing weather while allowing for soil expansion and easy winter harvesting. There is also the need for a Pot-in-Pot “socket” pot which decreases the chance of the “production” pot being frozen in the winter due to excess water.

U.S. Pat. No. 6,223,466 to Billings discloses a current Pot-in-Pot planting system. The disclosed device provides some gap between the inner and outer containers. However, this gap is tapered, resulting in undesired tilting of the “production” pot. In fact, the tapered gap intentionally allows for some misalignment of the vertical axes, as shown in FIG. 14, rather than for air pruning of the roots. Furthermore, the disclosed anchoring apparatus 30 on the “socket” pot requires that the hole be dug at a much larger diameter and then back filled. This is inadvisable since backfilling creates most of the problems with crushing of the “socket” pot. Similar deficiencies exist when installing the tapered pot shown in FIG. 2. The disclosed anchoring apparatus which requires separate components, as shown as item 32 in FIG. 7, avoids the problem of excessive backfilling but are cumbersome, to totally impractical, in hard soils.

U.S. Pat. No. 5,279,070 discloses a plant growing receptacle which allows nesting of a “production” nursery pot therein. The receptacle is anchored to the ground by high density materials placed at its bottom. The receptacle may be further secured to the ground by a stake. This device does not uniformly provide optimal stabilization for commercial nursery use. Further, such plant holding devices do not provide the plant with the temperature moderation of the ground. These devices also do not allow proper drainage and/or do not provide a sufficient air gap for root pruning, thus promoting penetration of roots into the ground and subsequent root damage when the production container and plant are removed. It also does not provide any control of water delivery from irrigation or rain.

Various forms of paper and plastic covers are disclosed in the prior art which cover the pot and plant during transportation. An example of such a cover is depicted in U.S. Pat. No. 6,810,638. These covers are designed to protect and shield the plant after harvesting rather than improve conditions during growing. These covers provide no means to deflect rain water or control moisture within the pot. There is a need for a simple cover for Pot-in-Pot production systems to deflect rain water and control moisture within the pot.

There is also a need for a simple, inexpensive system for growing potted nursery plants while preventing blowover during windy conditions or tipping while effectively controlling the temperature and moisture input to the plant. The present invention addresses all of these needs.

### BRIEF SUMMARY OF THE INVENTION

The present invention is a new Pot-in-Pot production system that facilitates growing nursery plants in containers while minimizing costs and the chance for blowover. This new system comprises a corrugated “socket” pot, a water deflecting cover, and an efficient, inexpensive drip irrigation device. These components, can be used independently, and therefore, also represent part of this invention.

The “socket” pot used as part of this invention has its vertical height encircled with at least one corrugation. This corrugation provides radial rigidity to minimize the chance of the “socket” pot crushing under the lateral forces of the surrounding ground. The corrugations also allow for physical engagement of the walls with the surrounding soil in multiple locations to help the “socket” pot stay in the ground during freezing weather and harvesting. Finally, the corrugations provide a noncontinuous, but straight surface in the vertical direction to hold the “production” pot, thus allowing for the necessary air space(s) to achieve root pruning.

A large diameter flange near the top of the presented “socket” pot acts as a reference surface for proper planting depth level during installation. This large flange may be sloped on the top surface to divert rain water or overhead irrigation away from the “socket” hole to minimize the amount of leachate water needing to be collected. Some additional weed control is also achieved.

The corrugated “socket” pot can also have atop lip for attachment of a cover to deflect water.

The water-deflecting cover, in combination with the features of the above described corrugated “socket” pot, effectively deflects rain water away from the “production” and “socket” pot. The water-deflecting cover can be of any shape, but a shallow conical form is preferred as the most effective at deflecting water. The water deflecting-cover can be constructed of any material including plastic, metal, translucent foam or waterproofed, fluted paper. Additionally, the surfaces of the cover may have reflective and absorptive properties to reduce water evaporation, control temperature, and deter insects. A flexible seal may be made between the water-deflecting cover and the plant stem to further control moisture within the system. The objective is to optimize the growing conditions of the plant to enhance growth.

The water-deflecting cover may contain inflatable sections to achieve the proper shape while also providing thermal insulation to moderate the temperature within the system.

The irrigation component of the disclosed Pot-in-Pot system is designed to precisely dispense water over the entire surface of the container and at a rate approaching that at which the plant is using the water. This slow and even delivery leads to healthy root growth with even distribution of hair roots throughout the root ball.

The irrigation component of the system can be a unitized mat placed on the surface of the “production” pot. This mat can be comprised of two material layers with fluid-conveying passageways for dispensing and metering the fluid to multiple outlet ports.

Alternatively, the irrigation component of the system can be incorporated into the water-deflecting cover, or attached to it. The irrigation component can form a vertically-oriented ring that drips in a circle into the “production” pot.

The layers of the irrigation component can be comprised of a number of different materials. These include coated paper, fiber, thermoplastics, polyethylene, polypropylene, polyester, nylon, thermoplastic elastomers, foam, and thermosets. At least one of the layers may have a bicomponent construction with a single surface having a lower-melt temperature layer. The material may also incorporate a reinforcing layer to increase durability.

Any conventional “production” pot or growing bag can be used with the components of the present invention. The “socket” pot and water-deflecting cover can be modified to adapt to or scaled to accommodate different-sized “production” pots.

The components can be used alone or in combinations to create a more efficient system for growing plants and reducing wastage.

The present invention further describes a method of enhancing the growth of containerized plants comprising: a corrugated “socket” pot, a water-deflecting cover, and an efficient irrigation device. The individual components work together as an integrated, synergistic system to optimize the growing conditions for the plant while reducing costs and maintenance.

The above and other objects, features and advantages of the present invention will be more clearly understood from the following detailed description taken in conjunction with the accompanying drawings.

### BRIEF DESCRIPTION OF THE SEVERAL VIEWS OF THE DRAWINGS

FIG. 1 is a cross sectional view of the present invention assembly installed in the ground.

FIG. 2 is a perspective view of the “socket” pot of the present invention.

FIG. 2A is a perspective view of the “socket” pot of the present invention with multiple corrugations.

FIG. 3 is a top view of the “socket” pot depicted in FIG. 2 or FIG. 2A.

FIG. 4 is a cross sectional view of the “socket” pot depicted in FIG. 2A.

FIG. 5 is a perspective, isometric view of the water-deflecting cover of FIG. 1

FIG. 6 is a perspective, isometric view of the irrigation component of the present invention depicted in FIG. 1.

FIG. 7 is a top plan view of the “production” pot depicting where the irrigation water is delivered by the irrigation component in FIG. 6.

FIG. 8 is a top plan view of a second embodiment of the irrigation component.

FIG. 9 is a cross sectional view of an alternative construction of the water-deflecting cover that incorporates the irrigation component.

### DETAILED DESCRIPTION OF THE INVENTION

While the present invention is capable of embodiments in various forms, thee is shown in the drawings and will hereinafter be described, a series of presently preferred embodiments with the understanding that the present disclosure is to be considered as an exemplification of the invention, and is not intended to limit the invention to the specific embodiments illustrated.

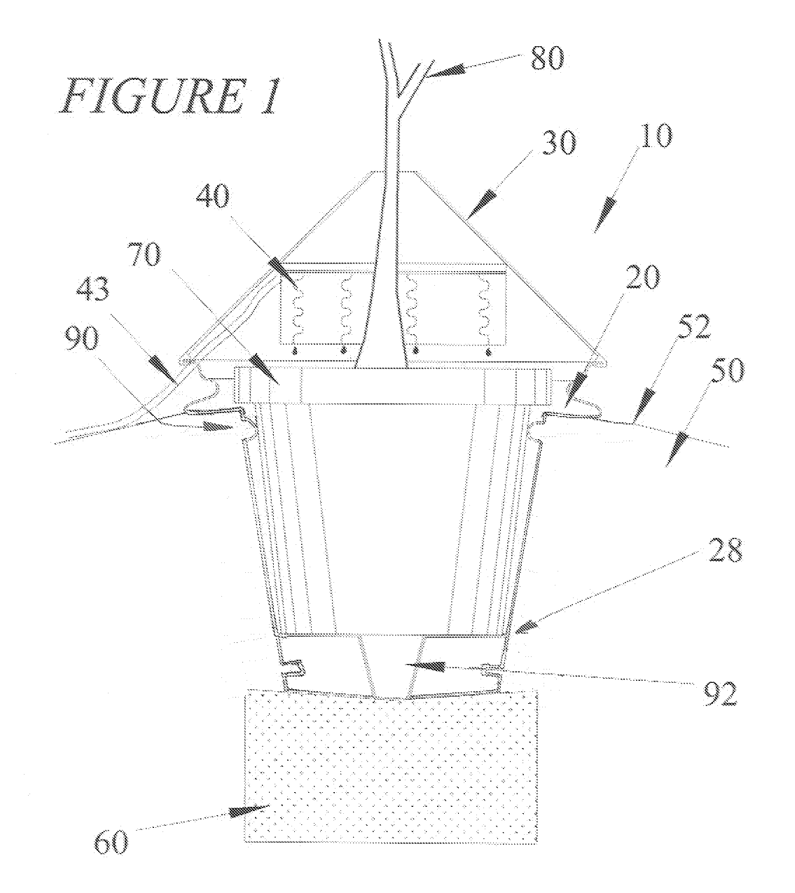

Referring now to the drawings, and more particularly to FIG. 1, the present invention is a new pot-in-pot production system, generally indicated at 10, comprises a “socket” pot 20, a water-deflecting cover 30, and an irrigation component 40. The “socket” pot 20 is buried in the ground 50 with some sand 60, or other provision for drainage in the installation hole below it. A “production” pot 70, holding the plant 80, is located generally within the confines of the system 10. It is understood that a growing bag can be used in place of pot 70.

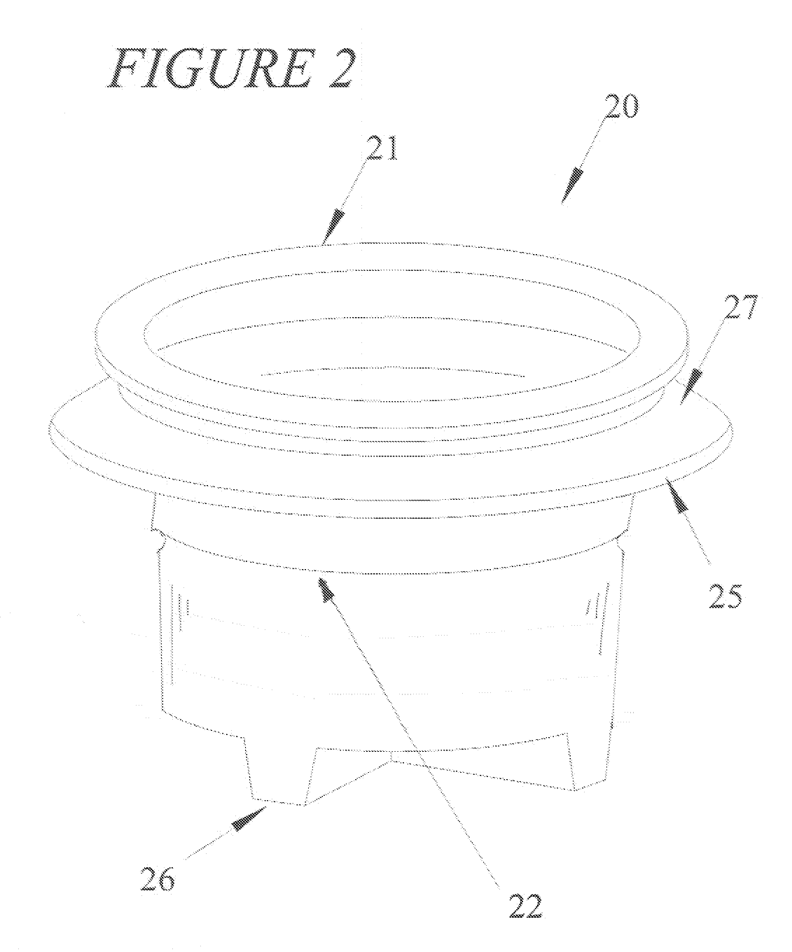

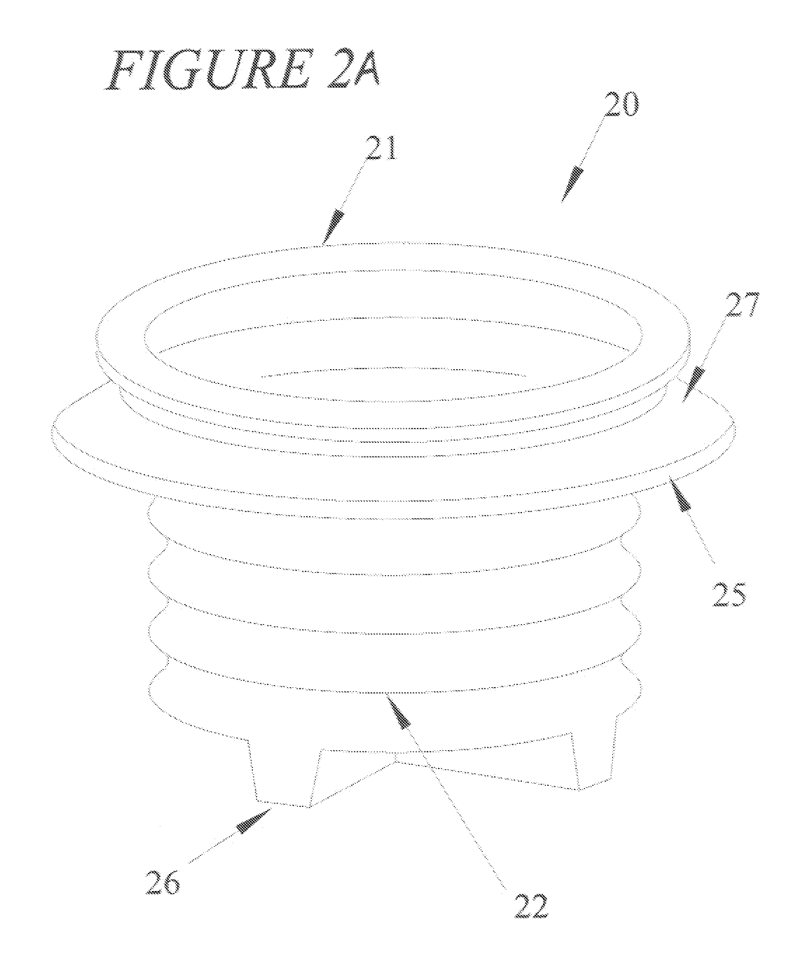

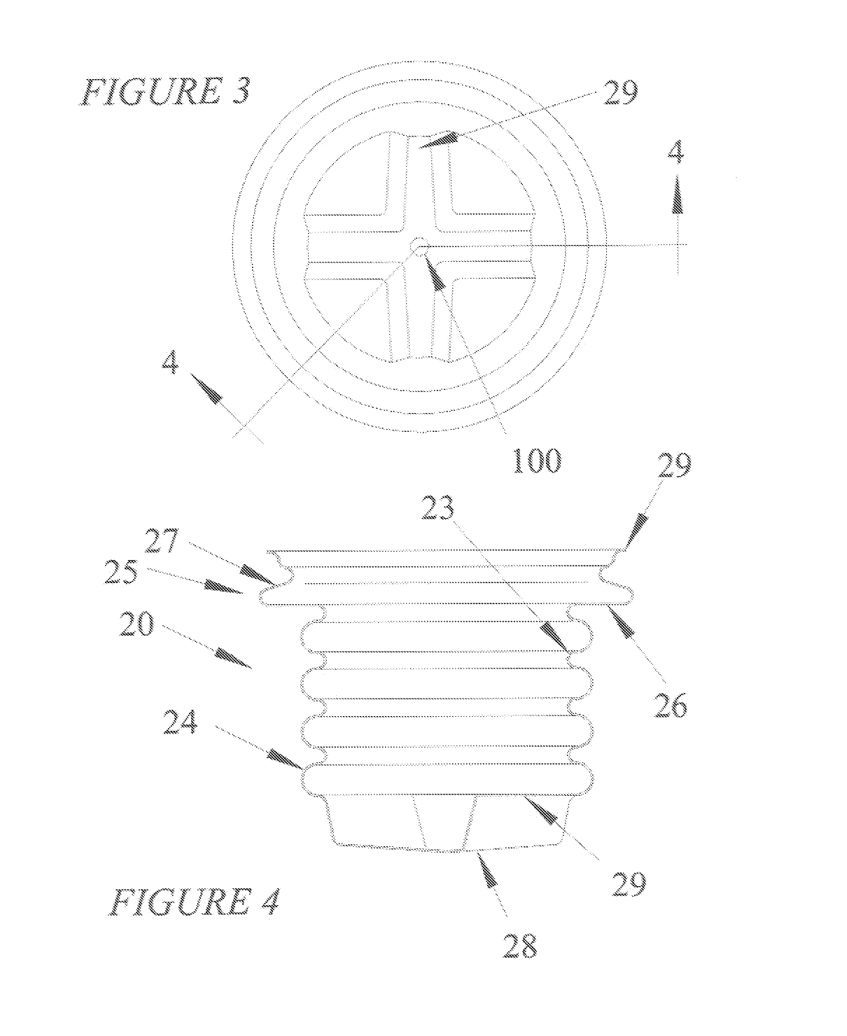

FIG. 2 depicts a generalized, isometric view of the “socket” pot of the current invention, generally indicated at 20. This embodiment is shown as being round but the “socket” pot can be any shape. FIG. 2 shows at least one corrugation. FIG. 2A shows multiple corrugations. As depicted in FIG. 3 and FIG. 4, the “socket” pot 20 is constructed of a thin wall of polymeric material, or the like, which is corrugated to create at least one ridge 22 extending at least inward and/or outward from the central form. The ridges 22 serve to enhance the hoop strength of the “socket” pot to avoid crushing by the surrounding soil 50. The inwardly projecting ridges 23 also serve to center and support the “production” pot 70 on the sides to avoid blowover or tipping of the tree. These inwardly projecting ridges 23 may be straight or decreasing in diameter to exactly match any taper of the “production” pot 70. The inwardly projecting ridges 23 also create a series of large air spaces 90 between the “socket” pot 20 and the “production” pot 70 to discourage undesirable root growth. The air spaces 90 also decrease friction between the pots, easing separation and inhibiting freezing together. The outwardly projecting ridges 24 are designed to interface with the surrounding ground 50 in a number of places to inhibit frost heaving and pulling out during harvesting.

An optional large diameter flange 25 provides a reference surface 26 for proper depth during installation as it rests on the surface 52 of the ground 50, as shown in FIG. 1. The top surface 27 of the large diameter flange 25 can be angled downwardly to deflect any airborne water, such as rain, or overhead spray irrigation from a neighboring field away from the installation hole.

The bottom 28 of the “socket” pot 20 incorporates an integral shelf 29 to uniformly support the “production” pot 70 while providing one or more bottom air spaces 92 between the two pots 20 & 70. These bottom air spaces 92 allow the air pruning function similar to the side air spaces 90 to minimize the problem of rooting out of the “production” pot 70.

The “socket” pot bottom 26 also has at least one hole 100 for drainage of any excess water into the sand 60. The shelf 29 is not continuous to allow water to find its way to the bottom hole 100.

There is an optional top lip 21 that securely interfaces with, and attaches to the water-deflecting cover 30, as seen in FIG. 1 and discussed below.

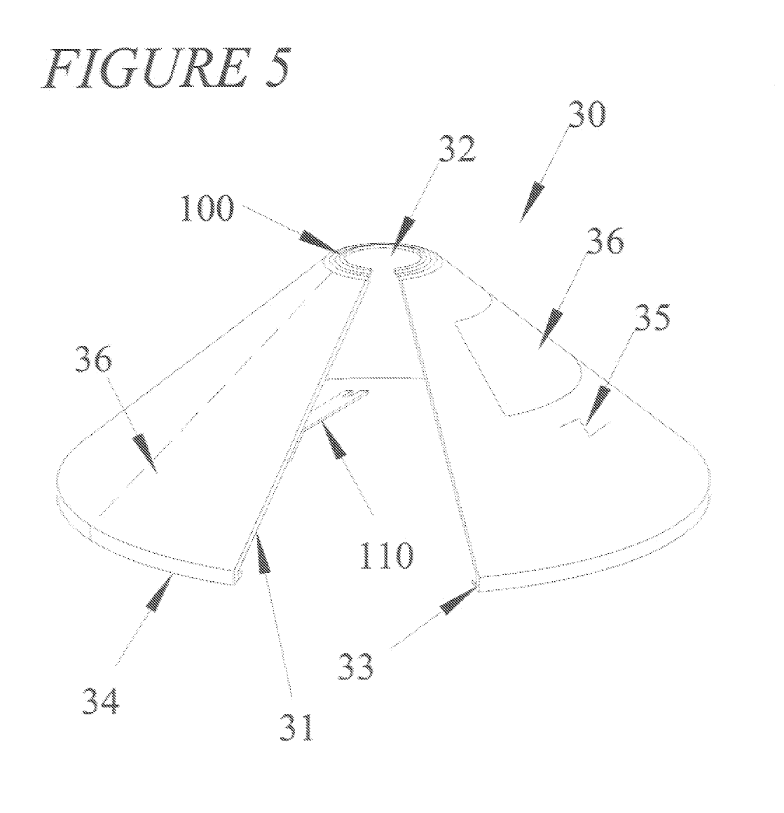

FIG. 5 is a generalized, isometric view of the water-deflecting cover 30 with it slightly open, as if during installation around the plant stem. Although the water-deflecting cover 30 can be of any shape that serves the function, the preferred embodiment is shown as conical in shape to deflect any airborne water away from entering the “socket” pot 20 and installation hole. The cover has an radial opening 31 and a top hole 32 for installation around the plant 80, as shown in FIG. 1. The water-deflecting cover 30 also incorporates one or more optional attachment means 33 at the bottom edge 34 to interface with the top lip 21 of the “socket” pot. The optional attachment means 33 helps hold the shape of the cover and secures the cover 30 from being blown off by strong wind.

The water-deflecting cover 30 and optional attachment means 33 can be designed for use in conjunction with the corrugated pot of FIG. 2 or any existing “socket” pot configuration. It is envisioned that the water-deflecting cover 30 would stay with the “socket” pot 20 after harvesting rather than being shipped with the “production pot” 70.

The water-deflecting cover 30 may be constructed of any material including; plastic, metal, semi-rigid foam or waterproofed paper. The outer surface 35 of the water-deflecting cover 30 may be black to retain heat early in the growing season or translucent white to reflect summer heat and allow some light through. In this way, the cover can provide some temperature moderation for the entire Pot-in-Pot system. Alternatively, the outer surface 35 may be a color that stimulates fruit production or have a smooth, highly reflective finish to ward off insects. Depending upon the material employed, the water-deflecting cover 30 can be made reversible to allow different characteristics. The cover can also be constructed to be flexible, as shown, or made of multiple rigid interconnecting segments 36 to ease shipping and handling.

An optional flexible bellows 100 can be incorporated at the opening 32 to seal around the stem of the plant 80 to further deflect water nom entering the production pot.

Conventional drip or spray emitters may be attached to the inside of the water-deflecting cover 30 to provide irrigation to the “production” pot 70. An optional emitter mounting bracket 110 may provided for doing so. The water-deflecting cover 30 can thus provide a steady mounting for the conventional emitter as it is accurately registered to the “production” pot 70. The water-deflecting cover 30 also provides protection from wind which can deflect the fine sprayed droplets emanating nom a micro-spray type emitter. In this manner, the water-deflecting cover 30 can be used to precisely control the amount of water being delivered to the plant and minimize wastage and leachate.

If the water-deflecting cover is opaque, an optional clear window 36 may be provided to allow viewing of the inside of the cover. This is particularly desirable when monitoring the irrigation device. If the water-deflecting cover 30 is constructed of multiple rigid interconnecting segments 36, one segment or more segments may be made of clear or translucent material to provide viewing of the inside.

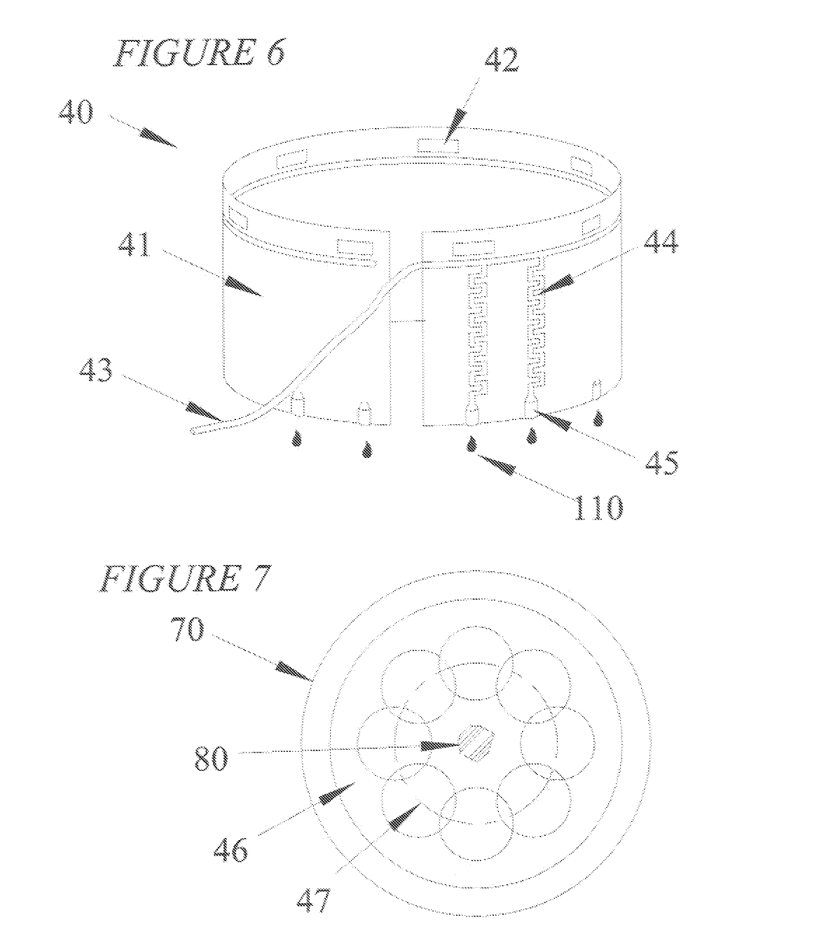

FIG. 6 depicts an isometric view of the irrigation component of FIG. 1 generally indicated at 40. The laminated assembly 41 is fabricated in a generally rectangular form, then shaped into a cylinder and attached to the water-deflecting cover 30. The laminated assembly 41 can constructed of thin polymeric materials and can simply hang down under its own weight from integrated hanging means 42 or it can be constructed of rigid materials to avoid deflection in the vertical dimension. The laminated assembly 41 may be designed to be removed and replaced, as required, without replacing the entire water-deflecting cover 30.

An integral tube section 43 is used to connect the inlet of the laminated assembly 41 to a irrigation fluid source (not shown). A network of integral fluid-conveying passageways 44 are configured to consistently provide irrigation fluid 110 to the multiple outlet ports 45, to achieve even distribution of the water at a low and uniform rate to minimize leachate.

The polymeric material layers of the laminated assembly 41 have fluid retaining properties and can include thermoplastics such as polyethylene, polypropylene, polyester, nylon, polyvinylchloride, thermoplastic elastomers, or the like, and may contain chemical stabilizers for improved durability. Material selection for the polymeric material layers 41 is based upon low cost, physical strength, the ability to form fluid-conveying passageways 44, and the ability to bond with fluid tight seals. The polymeric material layers may contain a portion of recycled plastics or fiber reinforcement (not shown).

FIG. 7 illustrates the even, circular distribution pattern 46 delivered by the irrigation component 41 depicted in FIG. 6 to the “production” pot 70. The diameter of the distribution pattern 47 is dictated by the final radius of curvature of the cylindrical laminated assembly 41 and its location in from the edge of the pot 70. The plant 80 is generally in the center of the circular distribution pattern 46. The fluid-conveying passageways 44 of the laminated assembly 41 restrict the flow of irrigation water 110 to a rate approximating that which the plant 80 is using it to minimize leachate. The large surface area of the laminated assembly 41 allow the fluid-conveying passageways 44 to have large cross sections to avoid plugging with debris in the water. There is also sufficient area to incorporate many outlet ports 45 for even distribution of the irrigation water 110.

The diameter of the distribution pattern 47 and rate of delivery may be selected to keep the irrigation water 110 well within the diameter of the production pot 70.

The present invention is thus able to distribute water evenly to the entire root ball of the plant, resulting in decreased leachate, less stress at harvesting, increased vitality, and longer shelf life.

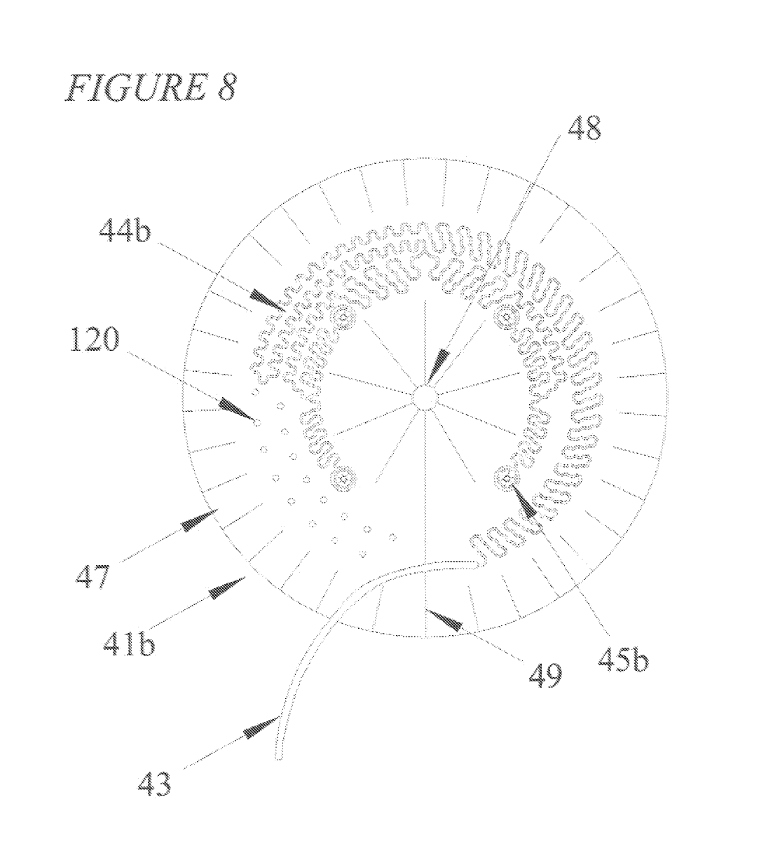

FIG. 8 depicts a top plan view of a second embodiment of the irrigation component of the current invention as a laminated assembly indicated at 41b designed to be placed on the surface of the growing media in the “production” pot 70. The laminated assembly 41b is made to cover the media surface and act as a plastic mulch ring around the base of the plant 80 to control weeds and minimize surface evaporation. The outer edge is sized to closely fit the “production” pot 70 or may optionally have flexible extensions 47 to allow for variations in the container size and shape. A serrated center opening 48 and slot 49 are provided for installing the device around the central stem of the plant 80 without exposure of any growing media in the “production” pot 70.

As in FIG. 6, this embodiment incorporates an integral tube section 43 to connect the irrigation component 43b to a irrigation fluid source (not shown). The laminated assembly 41b provides for the distribution of irrigation fluid thru fluid-conveying passageways 44b to optimally spaced outlet ports 45b within the area covered by the laminated assembly 41b.

The fluid-conveying passageways 44b of the laminated assembly 41b restrict the flow of irrigation water 110 to a rate approximating that which the plant 80 is using it to minimize leachate. The large surface area of the laminated assembly 41b allow the fluid-conveying passageways 44b to have large cross sections to avoid plugging with debris in the water. There is also sufficient area to incorporate many outlet ports 45b for even distribution of the irrigation water 110. In contrast to the embodiment of FIG. 6, the outlet ports 45b are not restricted to being on a diameter generally centered around the plant 80.

A plurality of perforations 120 maybe added through the laminated assembly 41b to provide aeration of the growing media. These are mechanically added in areas that do not interfere with the function of the fluid-conveying passageways 44b

It is envisioned that the laminated assembly 41b of this embodiment would be shipped with the “production” pot 70 after harvesting.

The laminated assembly 41b may be any color or texture to provide the plant 80 with optimum growing conditions or offer the desired appearance and protection after harvesting.

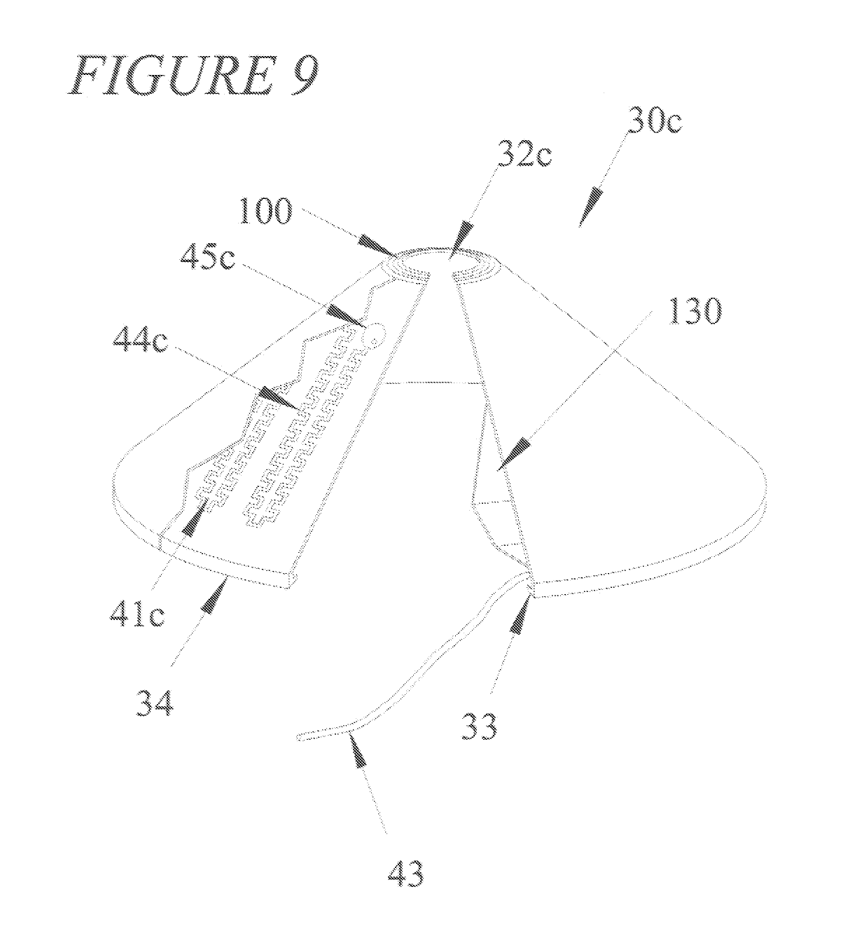

FIG. 9 shows a cross sectional view of a second embodiment of the water-deflecting cover 30e constructed of thin polymeric material layers. In this embodiment, the irrigation component 41e is made as an integral part of the water-deflecting cover 30e.

The irrigation component 41e provides for the distribution of irrigation fluid 110 from the integral tube section 43, thru a network of fluid-conveying passageways 44e, to a series of consistently and optimally spaced outlet ports 45c. Irrigation fluid 110 can be delivered at approximating the rate at which the plant uses it employing fluid-conveying passageways 44e and outlet ports 45c which are not prone to plugging from debris in the water.

As in the embodiment of FIG. 5, the color, transparency, and reflective properties of the surfaces for the water deflecting cover 30e and integrated irrigation component 41e may be varied to provide optimal growing conditions for the plant.

An optional flexible bellows 100 can also be incorporated in this embodiment at the opening 32c to gently seal around the stem of the plant 80. This flexible bellows 100 maybe made inflatable.

Optional inflatable air chambers 130 may also be incorporated to assist in holding the shape and provide enhanced thermal insulating properties of the device. Additional layers of polymeric material may be formed and bonded to the surfaces to provide insulating properties to the laminated assembly 41e. These pockets of air 130 may be either filled during manufacture or in the field, depending upon the design.

The present invention also includes a system for enhancing the growth of plants comprising the corrugated “socket” pot of FIG. 1 with the water-deflecting cover of FIG. 5, with the irrigation component of FIG. 6 or FIG. 8.

The present invention also include a system for enhancing the growth of plants comprising the corrugated “socket” pot of FIG. 2 or FIG. 2A with the water-deflecting cover with integral irrigation component of FIG. 9.

The present invention achieves significant advantage over prior Pot-in-pot production methods. First, the present invention controls the water entering the pit to minimize leaching. A further advantage of the present invention is that the irrigation water is delivered in very small amounts and very evenly over the surface so as to develop superior root systems.

Secondly, the present invention achieves the benefits of mulch covers, such as reduced water evaporation, less weeds, control of soil and irrigation fluid temperatures leading to earlier and higher yields or extended growing seasons, and a desirable appearance when harvested.

Those trained in the art will recognize that the various components and features shown as part of any of the above-mentioned embodiment can be incorporated into other embodiment or combinations, including embodiment and combinations not depicted and described herein.

Various changes in the details of the illustrated construction may be made within the scope of the appended claims without departing from the true spirit of the invention. The present invention should only be limited by the following claims and their legal equivalents.

I claim:

1. A pot-in-pot growing system comprising:
a socket pot container having a side wall with at least one corrugation and a bottom end made integral with said side wall;
a planting pot container removably placed in said socket pot container, said planting pot container having an exterior surface in intermittent contact with said at least one corrugation;
a cover of flexible material removably attached to said socket pot container; and
an irrigation component positioned under said cover.

2. The growing system of claim 1, wherein at least two corrugations have decreasing diameters from top to bottom of said side wall.

3. The growing system of claim 1, wherein said socket pot container has a flange at a top end thereof.

4. The growing system of claim 3, wherein said flange is sloped.

5. The growing system of claim 1, wherein said socket pot container has a lip at a top edge thereof, said cover being removably attached to said lip.

6. The growing system of claim 1, wherein said socket pot container has an integral shelf at a bottom end thereof, said planting pot container being in contact with said integral shelf.

7. The growing system of claim 6, wherein said integral shelf makes partial contact with a bottom of said planting pot container.

8. The growing system of claim 1, wherein said cover has an opening through said flexible material.

9. The growing system of claim 8, further comprising:
a means for sealing said opening around a plant.

10. The growing system of claim 1, wherein said cover is invertable.

11. The growing system of claim 1, wherein said cover is conical.

12. The growing system of claim 1, wherein said cover is colored.

13. The growing system of claim 1, wherein said cover is translucent.

14. The growing system of claim 1, wherein said cover has an attachment means to removably engage said socket pot container.

15. The growing system of claim 1, wherein said cover has air pockets.

16. The growing system of claim 1, wherein said cover has a support means to removably engage said irrigation component.

17. The growing system of claim 1, wherein said cover and said irrigation component are made integral.

18. The growing system of claim 17, wherein said cover and said irrigation component are comprised of a laminated assembly of polymeric material layers.

19. The growing system of claim 18, wherein said laminated assembly is further comprised of an additional polymeric material layer selectively bonded to said laminated assembly, forming at least one region of air.

20. The growing system of claim 18, wherein said polymeric material layers are comprised of a material, said material being selected from a group consisting of: thermoplastics, polyethylene, polypropylene, polyester, nylon, thermoplastic elastomers and thermosets; and a chemical stabilizer

21. The growing system of claim 18, wherein at least one of the polymeric material layers is of bicomponent construction with a single surface have a lower-melt temperature layer.

22. The growing system of claim 18, wherein said laminated assembly incorporates fluid-conveying passages configured to provide irrigation fluid to multiple outlets.

23. The growing system of claim 22, wherein said multiple outlet ports are larger than said fluid-conveying passages.

24. A socket pot container of a pot-in-pot growing system comprising:
a side wall with at least one corrugation; and
a bottom end made integral with said side wall along an entire perimeter thereof.

25. The socket pot container of claim 24, wherein said bottom end is circular, said side wall being cylindrical.

26. The socket pot container of claim 24, wherein said bottom end is circular, said side wall being conical and having multiple corrugations with decreasing diameters toward said bottom end.

27. The socket pot container of claim 24, further comprising:
a flange at a top end of said side wall.

28. The socket pot container of claim 27, wherein said flange is sloped.

29. The socket pot container of claim 27, wherein said flange is larger than said at least one corrugation.

30. The socket pot container of claim 24, further comprising:
a lip at a top edge of said side wall.

31. The socket pot container of claim 24, further comprising:
an integral shelf at said bottom end.

32. The socket pot container of claim 24, further comprising:
an air pocket at said bottom end.

33. The socket pot container of claim 24, further comprising:
an aggregate drainage layer in contact with said bottom end.
